(19) United States
(12) Patent Application Publication
(10) Pub. No.: US 2015/0276684 A1
(43) Pub. Date: Oct. 1, 2015

(54) Method and Device for Avoiding and/or Detecting Stress Cracks in a Component as a Result of Hardening or Straightening

(71) Applicant: Ulrich SEUTHE, (US)

(72) Inventor: Ulrich Seuthe, Wetter (DE)

(21) Appl. No.: 14/434,832

(22) PCT Filed: Oct. 10, 2013
(86) PCT No.: PCT/EP2013/003045

§ 371 Date: Apr. 10, 2015

(30) Foreign Application Priority Data
Oct. 10, 2012 (DE) 20 2012 009 675.3

(51) Int. Cl. G01N 29/14; B21D 1/00

(52) U.S. Cl. CPC G01N 29/14; B21D 1/00; G01N 2291/023; G01N 2291/0289; G01N 2291/014; G01N 2291/011

(57) ABSTRACT

The invention relates to devices and methods and arrays for detecting and avoiding stress cracks. One embodiment relates to a device for detecting a crack formation in a component as a result of hardening of the component under heat treatment, such as inductive hardening or flame hardening, for example, and/or resulting from straightening the component, comprising a sound sensor that can be coupled with the component to register structure-borne sound. The device is configured for the frequency-based and/or time-based evaluation of sound signals registered by the sound sensor during the hardening and/or during the straightening process.

### FIELD OF THE INVENTION

The invention relates to devices and methods and arrangements for detecting and avoiding stress cracks, in particular a device, a method and an arrangement respectively according to the preambles of claims 1, 11 and 18.

### TECHNICAL BACKGROUND

Hardening processes on the basis of a heat treatment, in particular a local heat treatment, that is not carried out in the furnace, such as for instance induction hardening or flame hardening, in order for example to harden large metal components, are known in the prior art.

Inductive hardening is one of the surface hardening processes. In an outer zone of a component near the surface, a martensitic hardening, and consequently an increase in hardness, is brought about by a controlled series of heating/quenching. By contrast, the microstructure and hardness in the core of the component remain uninfluenced. Alternating current is usually applied to a coil, thereby creating a magnetic field, which induces eddy currents in the outer layer of a metal component, leading to local heating. The surface is heated up to the required hardening temperature and is subsequently quenched, for example with a sprinkler. The depth of penetration of the eddy currents depends here on the frequency of the alternating current in such a way that the depth of penetration increases with decreasing frequency. Typical frequencies lie in the range of 50-500 kHz.

In the case of flame hardening, the surface of a metal component is likewise locally heated and cooled by means of gas burners or the like.

In the case of inductive hardening, flame hardening and also other heat treatment processes, crack formation in the component may occur in the course of the heating, quenching and/or cooling as a result of thermal stresses. In order to detect such stress cracks, it is known in the prior art to subject each induction-hardened, flame-hardened or otherwise heat-treated component to an individual test. A commonly used test method is the magnetic powder method. Similarly, dye penetration methods are used.

Stress cracks may also occur in a component in the course of straightening, in particular bending and straightening. These cracks cannot be detected during the straightening operation.

A disadvantage of the known hardening and straightening is that a separate production step is required for testing for stress cracks. Thus, each component has to be laboriously examined after the hardening and cooling or straightening. This increases the costs and the production time.

### SUMMARY OF THE INVENTION

Against this background, the invention is based on the object of providing devices and methods and arrangements for detecting and avoiding stress cracks, in particular a device, a method and an arrangement respectively according to the preambles of claims 1, 11 and 18, that are quicker and less costly and avoid stress crack formation.

This object is achieved by the features of claims 1, 11 and 18.

Accordingly, a device is provided for detecting crack formation in a component as a result of hardening under heat treatment, in particular local heat treatment, such as for instance inductive hardening or flame hardening of the component, or in the course of straightening, in particular in the course of bending and straightening, comprising a sound sensor that can be coupled with the component with respect to structure-borne sound, the device being designed for particularly frequency-time-based evaluation of sound signals sensed by the sound sensor during the hardening and/or straightening.

The sensing of structure-borne sound and the frequency-time-based evaluation of the structure-borne sound while the hardening or straightening is still in progress provides for the first time an in-process check in the course of the straightening, for example bending and straightening, or in the course of the hardening, i.e. inductive hardening, flame hardening or the like, that can detect the formation of cracks while the process is still underway. It is possible to dispense entirely with a time-intensive and laborious, separate testing stage following the straightening or hardening. Considerable cost savings are obtained.

For this purpose, a sound sensor, for example of the piezo type, is coupled to the component with respect to structure-borne sound, i.e. is connected to the component in such a way that sound waves can be transmitted from the component to the sound sensor. This may take place by the sound sensor being mounted directly on the component. However, the sound sensor is preferably fixedly mounted on a holding device of the component, so that sound signals occurring in the are transmitted via the holding device to the sound sensor.

The sound sensor senses sound signals as a function of time. The sound signals can, if need be, be presented as a three-dimensional frequency-time diagram with time (or a variable derived therefrom) along one axis, the frequency (or a variable derived therefrom) along another axis and a value proportional to the sound energy or sound intensity, or in some other mathematical relationship with it, along yet another axis. Instead of time, a function that is based on time may also be chosen; the same applies to the frequency and the sound energy. What is presented is merely for the purpose of visualizing the concept.

To detect whether a crack has occurred, during the hardening the sound energy or sound intensity in certain frequency ranges at certain times is sensed and evaluated (frequency-time-based evaluation). On the basis of the evaluation, crack formation can be detected directly. Plastic flow processes in the course of straightening, or generally in the course of forming, may also be detected. It is similarly possible initially only to sense the sound profile during the straightening and/or hardening, assign it to the component and evaluate it later.

What is essential to the invention is the sensing of sound from a component while the straightening and/or hardening is still in progress. The frequency resolution can remain low, for example up to a few hundred kHz, or go up to frequencies that have previously been unusual for structure-borne sound analyses of up to 50 MHz (for example 100 kHz, 500 kHz, 1 MHz, 2 MHz, 5 MHz, 10 MHz, 50 MHz).

In particular in the case of inductive hardening, the component is induced to undergo strong vibrations, mainly in the range of the electrical field oscillation. This involves using a KHz but also high or multiple excitation frequencies. These vibrations are generally within certain frequency bands, which generally vary in their frequency and amplitude during the process.

A 2-dimensional analysis, corresponding to the prior art, of what happens in the process fails here to present the dynamics of the frequency and amplitude changes at the various frequencies. This information however provides an indication of the energy transmission to the component and provides an estimate of the energies at different depths of penetration.

The quantitative evaluation of the multiple excitation frequencies or their effects in the component while the inductive hardening is in progress allows conclusions to be drawn with respect to the depth of hardness and the hardness achieved.

In addition, microstructural transformations and crack formations cause emissions that can be distinguished from the excitation frequencies on the basis of their completely different frequency pattern.

In particular, crack formation can be detected even within strong induction emissions on the basis of its wideband form, corresponding in appearance to a pulse response.

In the case of other heat treatment processes, such as for example flame hardening, non-periodic emissions tend to occur instead, as a result of the energy introduced by gas burners. These excitation energies thus cannot be analyzed in individual bonds. However, they usually have an upper frequency limit, so that crack formation can be detected during the heating above these frequencies.

After the end of the heating, and this applies to all processes, the frequency analysis can distinguish the emission frequencies of the quenching by the cooling medium into noises due to the introduction of the cooling medium from microstructural changes, plastic changes and spontaneous or cumulative crack formation.

If an assessment of the amplitudes over time is also used for the frequency analysis, then it is possible in such a consideration of the overall dynamics as it were to use the shape in the frequency-time diagram for the assessment of a number of process characteristics.

The device can signal a classification of the component on the basis of the number and/or thickness of the cracks detected, i.e. for example store it in a file, indicate it by an optical signal or generate a control signal.

The evaluation expediently takes place in this case in real time, while the heating, quenching and/or cooling of the component is still in progress.

The invention can be realized particularly easily by the energy of the sound signals that is integrated in a time window, possibly above a lower frequency limit value, being compared with a threshold value and crack formation being detected if it is exceeded. There is no need here for a detailed consideration of the frequency, and the device can be of a relatively simple construction.

In the case of induction hardening, a bandpass filter or the like with a limiting frequency above the induction frequency may be provided for this purpose, so that sound signals of the induction hardening itself are ignored.

The time window is expediently chosen in such a way that it corresponds to a material- and/or process-dependent time segment for the occurrence of a crack or a phase of the hardening.

Different crack-category threshold values may be provided for comparing with the integrated intensity of sound signals sensed within a frequency window and/or time window. This allows a classification of the cracks to be easily presented, for example in the categories “smallest possible crack”, “small crack”, “moderate crack”, “large crack”, etc.

If different crack-category threshold values are provided for two time segments of the hardening process, can be more flexibly crack-detected. For instance, different threshold values during quenching than in the course of cooling may be expedient.

A particularly simple design detects a defective component with one or more cracks whenever a total amount of energy of the sound signals sensed from a starting point in time is exceeded. Here, the total energy that is sensed by the sound sensor in frequency ranges above the induction frequency is simply added up; this energy can only originate from cracks. Alternatively, a higher limit value may also be used, and the induction sound may possibly also be integrated as well.

In one design it may be provided that a crack is detected when a total amount of energy of the sound signals sensed in a concurrent time window is exceeded. The time window corresponds approximately to the time duration of a crack, but may also be much longer, for example 1/10 s. If the threshold value of the added-up energy is exceeded within every tenth of a second, a crack is detected and the component is classified as defective. This embodiment, in a digital design, manages with a minimum of intermediate memory for the sound signals.

The invention also provides a method for detecting crack formation in a component as a result of hardening involving heat treatment, in particular local heat treatment, of the component, such as for instance inductive hardening or flame hardening, and/or as a result of straightening of the component, in particular bending and straightening of the component, a frequency evaluation and/or time evaluation of sound signals sensed during the hardening or straightening by a sound sensor coupled with the component with respect to sound being carried out. The sound signals sensed are in this case structure-borne sound emissions that occur in the component in the course of the hardening or straightening of the component.

The method can make it possible for the component to be classified on the basis of the number and/or thickness of the cracks detected.

The structure-borne sound emissions are expediently evaluated during the heating, quenching and/or cooling of the component or during the straightening, in particular in real time.

The energy of the sound signals that is integrated in a time window, possibly above a lower frequency limit value, is advantageously compared with a threshold value and crack formation is detected if it is exceeded. A material- and/or process-dependent time segment for the occurrence of a crack or a segment that corresponds to a phase of the hardening or straightening may be chosen as the time window.

The method may use different crack-category threshold values for comparing with the integrated intensity of sound signals sensed within a frequency window and/or time window.

Different crack-category threshold values are expediently used for a number of time segments, for example two different time segments, of the hardening process or straightening process.

In the case of induction hardening, a bandpass filter or the like with a limiting frequency above the induction frequency may be used.

When a total amount of energy of the sound signals sensed from a starting point in time is reached or exceeded, a crack can be detected. Possibly, when a total amount of energy of the sound signals sensed in a concurrent time window is exceeded, a crack can be detected.

The invention also provides a method and a device for avoiding stress cracks in the course of the forming, in particular straightening, in particular bending and straightening, of a component, in particular before, during or after hardening of the component, in particular by the method described above and/or with the device described above, comprising a (frequency-time) analysis in real time, the component being subjected to an increasing forming force and structure-borne sound emissions thereby being sensed, the structure-borne sound emissions being evaluated by (frequency-time) analysis in real time, in order to detect structure-borne sound emissions induced by plastic deformation.

The forming may (i) be ended or interrupted after the detection of structure-borne sound emissions induced by plastic deformation and subsequently continued with the same forming force or a reduced forming force or (ii) after the detection of structure-borne sound emissions induced by plastic deformation, the forming may be continued with an automatically controlled forming force, at which the structure-borne sound emissions that are induced by plastic deformation and are sensed and detected in real time do not increase any further or remain in a fixed energy range or amplitude range.

The forming may be ended, i.e. interrupted or conclusively ended, after a certain time period after commencement of the structure-borne sound emissions induced by plastic deformation. The forming may furthermore be ended after the exceeding of a threshold value for the integrated-together energy of the structure-borne sound emissions, in particular the structure-borne sound emissions induced by plastic deformation. The forming may be ended after the exceeding of a threshold value for the amplitude of the structure-borne sound emissions, in particular the structure-borne sound emissions induced by plastic deformation.

For the ending of the forming, the forming force may be discontinued, reduced or maintained at the last value. After the ending of the forming, the component may once again be subjected to a forming process, so that the ending here corresponds to an interruption in the overall forming process. Expediently, a number of individual loading thrusts are carried out one after the other until the desired final form of the component is achieved.

The invention also provides an arrangement for straightening a component by plastic forming, in particular in a way corresponding to the method described above, comprising a straightening device for producing a forming force, a structure-borne sound sensor for attaching to a component to be straightened, and also a controller, which senses structure-borne sound emissions during the acting of the forming force on the component and evaluates them in real time and, if structure-borne sound emissions that are produced by plastic deformation of the component are detected, controls the straightening device in such a way that the forming is ended.

Plastic flow processes in the component are hereby detected on the basis of characteristics that can be determined empirically or analytically, for example certain patterns in the time-frequency spectrum and, when these flow processes are detected, the commencement of the plastic deformation of the component is detected. The forming force is then no longer increased, whereby stress cracks are avoided, but instead is controlled or automatically controlled to a force above the force required for the plastic forming and below a force that leads to cracks, in particular stress cracks, in the component.

The controller may be designed in such a way that, for ending the forming, the straightening device is controlled to discontinue the forming force or to maintain the forming force or is automatically controlled to reduce the forming force—in particular to a value at which the amplitude and/or energy of the structure-borne sound emissions that are produced by the plastic deformation of the component does/do not increasing any further or does/do not exceed a threshold value.

The arrangement is expediently designed for the forming to be repeated after it has been ended, until the component reaches a desired final form. This allows the component to be formed into the desired final form by successive loading thrusts, while avoiding an excessive forming force that could lead to (stress) cracks.

The arrangement may be a straightening device, in particular a bending and straightening device.

Further features and embodiments of the invention emerge from the following description, the figures and the claims.

### BRIEF DESCRIPTION OF THE FIGURES

FIG. 1 illustrates a device according to the invention.

FIG. 2 illustrates a three-dimensional frequency-time diagram.

FIGS. 3 and 4 show a frequency-time diagram of an induction hardening process in 3D and in a plan view of the frequency-time plane.

FIGS. 5 and 6 show the induction hardening process from FIGS. 3 and 4 in another time window.

FIGS. 7 to 12 show a further induction hardening process as 3D frequency-time diagrams and in sections.

FIGS. 13 and 14 show a frequency-time diagram of an induction hardening process in 3D.

FIGS. 14 and 15 show a frequency-time diagram of the induction hardening process from FIGS. 13 and 14 in another time window in 3D and in plan view of the frequency-time plane.

### DETAILED DESCRIPTION OF EXEMPLARY EMBODIMENTS

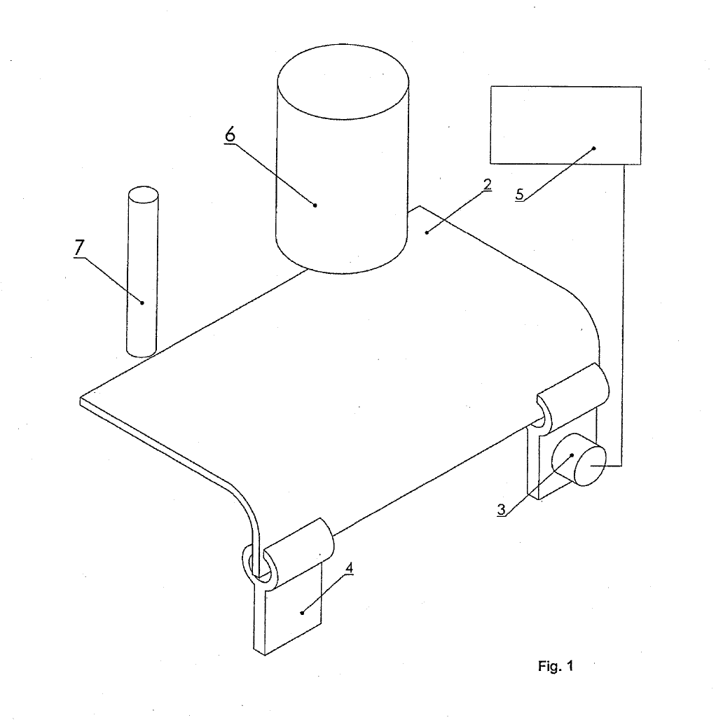

The device 1 represented in FIG. 1 for detecting crack formation in a component 2 as a result of inductive hardening of the component 2 comprises a sound sensor 3, which here is fastened to a holder 4 for the component 2 and senses sound signals produced in the component 2. An evaluation unit 5, which is shown separately here, is coupled with the sound sensor and evaluates the sound while the component 2 is locally heated by means of a coil 6, for example a movable coil, and is subsequently quenched by means of coolant 7. In the case of flame hardening, a burner or the like is used instead of the coil 6.

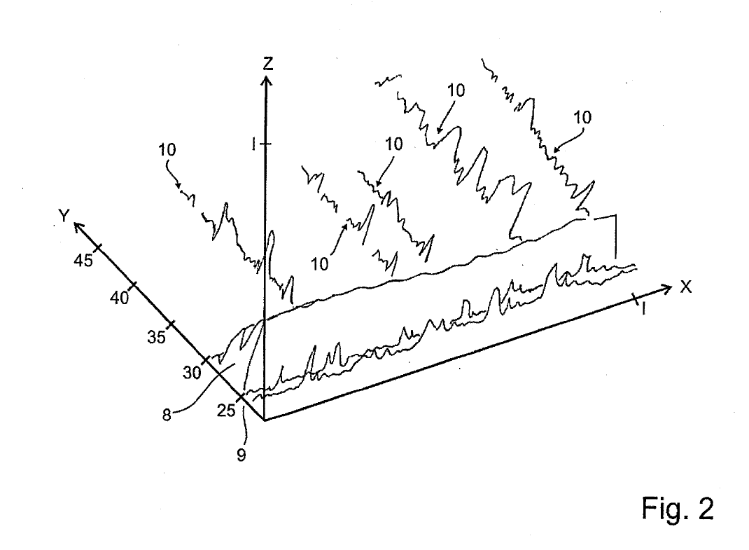

A typical frequency-time spectrum is illustrated in FIG. 2. A value that is in a relationship with the sound intensity or the energy of the sound is plotted along the z axis, while the time and the frequency (or functions thereof) are respectively plotted along the x axis and the y axis.

It can be seen that, as a feature attributable to the induction, a peak 8 is formed as constant over time, here for example between 25 and 30 kHz. With a lower frequency, sound produced by the coolant 7 is sensed by the sound sensor 2 in the region 9.

In the case of induction hardening, cracks take place at substantially discrete points in time, that is to say rapidly. In the case of a crack, sound energy is released with a certain sound spectrum, which depends among other things on the length and width of the crack, the nature of the material, etc. Five cracks 10 can be seen, each with a different sound spectrum.

According to the invention, the energy that is produced above the peak 8 is used to detect a crack, with or without frequency evaluation therefor. A pattern detection may be used for example for this, in order to detect cracks in a frequency-time diagram. However, it is particularly expedient to add up the sound energy above a limit value, shown here above the peak 9 at 40 kHz, and compare it with a crack-formation limit value. If the crack-formation limit value is exceeded, a crack has occurred.

The sensing and evaluation expediently take place digitally, i.e. values sensed by the sound sensor 2 are digitized, possibly frequency-analyzed, and digitally processed.

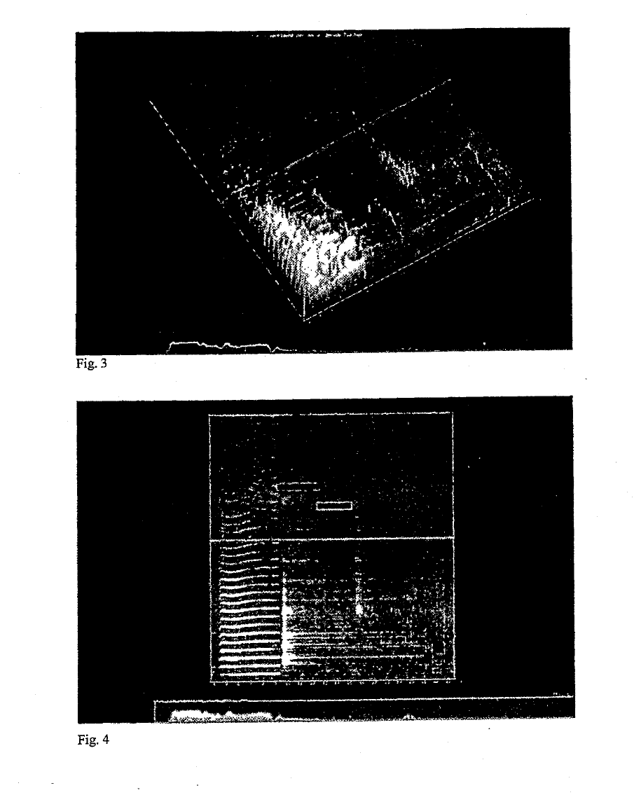

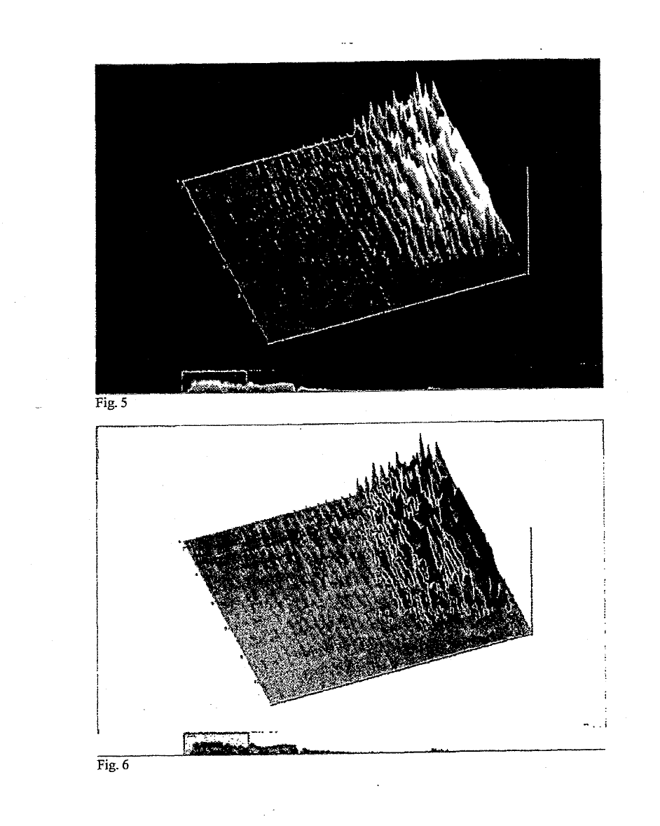

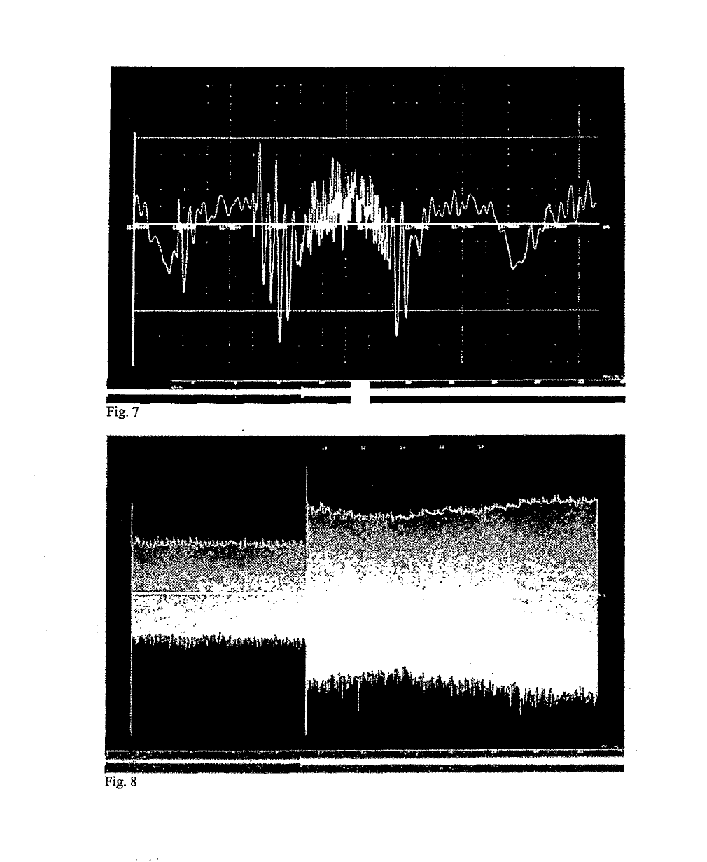

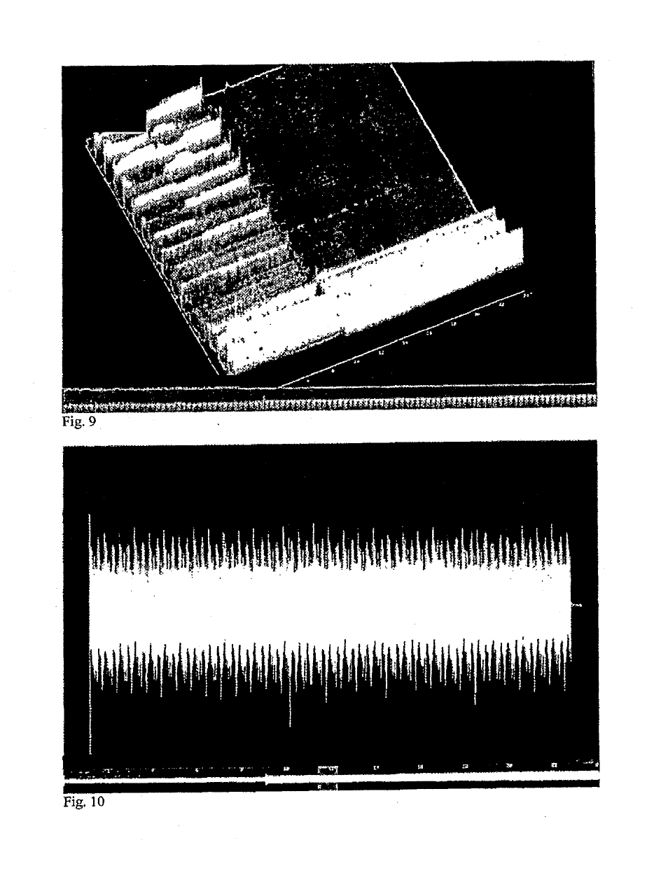

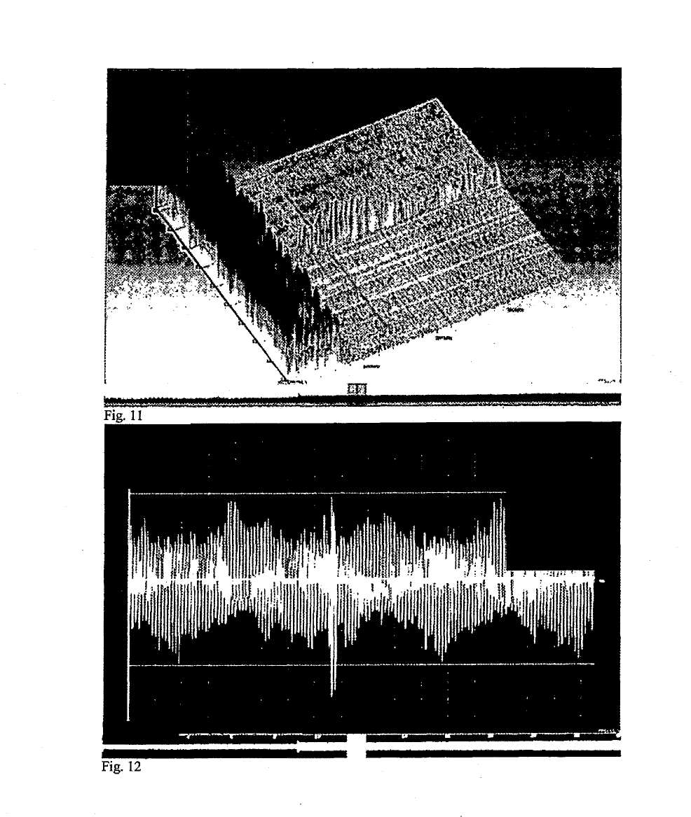

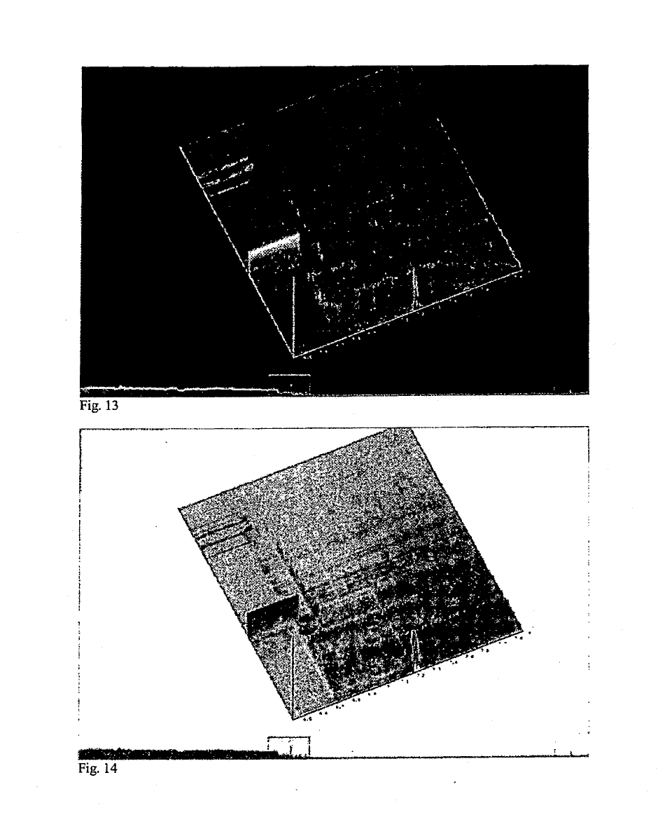

Examples of frequency-time diagrams from actual inductive hardening processes are shown in FIGS. 3 to 16. It can be seen that the characteristics schematically illustrated above in FIG. 2 are obtained.

A further aspect of the invention concerns plastic forming, for example monitored straightening, in particular bending and straightening.

In the course of forming, in particular the forming of hardened materials, cracks may occur.

A plastic deformation of the material is desired, whereas crack formation is not.

Crack detection by means of structure-borne sound when the crack occurs is state of the art in the case of some production processes.

This method is used extremely successfully in the straightening of transmission shafts, engine components and steering components. The pulse energy released due to the crack formation is captured here by sensors that are sensitive over a wide band in the frequency range, filtered and assessed and the result reported to the working machine.

This method allows 100% crack monitoring during production.

It would additionally be desirable to suppress the crack formation itself.

If material changes that precede the crack can be detected on the basis of their pulse emissions, a signal can be sent to the working machine, for example a bending machine, already before cracking, in order in this way to avoid the actual crack, for example by reducing or discontinuing the forming force.

A precondition is that the emissions caused by strong plastic material displacements, emissions that are very small in comparison with crack formation, can be separated from the production noises.

This is successfully accomplished by using a sensitive sensor and amplifier technology and also a real-time frequency analysis on the basis of the technique of WO 2010/051954.

It is thereby possible to detect extremely small emissions in the frequency pattern and separate them from the often strong production-induced working noises of the machine.

It is thereby also possible not to deform the component cyclically with slowly increasing loading, but instead to increase the forming force gradually until emissions caused by plastic deformations occur, which then represent an indication of actually successful forming.

It has been the practice until now to apply loading to the component and check after one or more loading displacements whether the geometry has changed.

This meant that the machine used trial and error to establish the actual plastic forming.

With the structure-borne-sound-monitored forming outlined above, a plastic deformation is achieved in every loading displacement, while at the same time crack formation is avoided. For this purpose, the forming force can be automatically controlled, with feedback of the sound signal emissions, sensed by frequency-time analysis, caused by plastic deformations that precede a crack.

An arrangement is provided for this purpose, comprising a straightening device and a controller, which picks up the structure-borne sound from a sensor and subjects it to a frequency-time analysis in real time, in order for example to detect characteristic patterns that indicate a plastic deformation. If such a plastic deformation is detected, crack formation can be avoided by the forming force being discontinued or reduced.

1. A device for detecting crack formation in a component as a result of hardening under heat treatment of the component, such as for instance inductive hardening or flame hardening, and/or as a result of straightening of the component, comprising a sound sensor that can be coupled with the component with respect to structure-borne sound, characterized in that the device is designed for frequency- and/or time-based evaluation of sound signals sensed by the sound sensor during the hardening and/or straightening.

2. The device as claimed in claim 1, characterized in that the device signals a classification of the component on the basis of the number and/or thickness of the cracks detected.

3. The device as claimed in claim 1, characterized in that the evaluation takes place during the heating, quenching, cooling, or combinations thereof of the component.

4. The device as claimed in claim 1, characterized in that the energy of the sound signals that is integrated in a time window is compared with a threshold value and crack formation is detected if it is exceeded.

5. The device as claimed in claim 4, characterized in that the time window corresponds to a material-dependent time segment, process-dependent time segment, or combinations thereof for the occurrence of a crack or a phase of the hardening or straightening.

6. The device as claimed in claim 1, characterized in that different crack-category threshold values are provided for comparing with the integrated intensity of sound signals sensed within a frequency window, time window, or combinations thereof.

7. The device as claimed in claim 6, characterized in that different crack-category threshold values are provided for two time segments of the hardening process or straightening process.

8. The device as claimed in claim 1, characterized in that a bandpass filter or the like with a limiting frequency above the induction frequency is provided for the induction hardening.

9. The device as claimed in claim 1, characterized in that a crack is detected when a total amount of energy of the sound signals sensed from a starting point in time is exceeded.

10. The device as claimed in claim 1, characterized in that a crack is detected when a total amount of energy of the sound signals sensed in a concurrent time window is exceeded.

11. A method for avoiding stress cracks in the course of the forming, in particular straightening, of a component, in particular during or after hardening of the component, comprising a frequency-time analysis in real time, the component being subjected to an increasing forming force and structure-borne sound emissions thereby being sensed, the structure-borne sound emissions being evaluated by frequency-time analysis in real time, in order to detect structure-borne sound emissions induced by plastic deformation, and the forming being ended after the detection of structure-borne sound emissions induced by plastic deformation.

12. The method as claimed in claim 11, characterized in that the forming is ended after a certain time period after commencement of the structure-borne sound emissions induced by plastic deformation.

13. The method as claimed in claim 12, characterized in that the forming is ended after the exceeding of a threshold value for the integrated-together energy of the structure-borne sound emissions, in particular the structure-borne sound emissions induced by plastic deformation.

14. The method as claimed in claim 11, characterized in that the forming is ended after the exceeding of a threshold value for the amplitude of the structure-borne sound emissions, in particular the structure-borne sound emissions induced by plastic deformation.

15. The method as claimed in claim 11, characterized in that, for the ending of the forming, the forming force is discontinued, reduced or maintained at the last value.

16. The method as claimed in claim 11, characterized in that, after the ending of the forming, the component is once again subjected to a forming process.

17. The method as claimed in claim 16, characterized in that a number of forming processes are carried out one after the other until the desired final form of the component is achieved.

18. An arrangement for straightening a component by plastic forming, in particular in a way corresponding to the method as claimed in claim 11, comprising a straightening device for producing a forming force, a structure-borne sound sensor for attaching to a component to be straightened, and also a controller, which senses structure-borne sound emissions during the acting of the forming force on the component and evaluates them in real time and, if structure-borne sound emissions that are produced by plastic deformation of the component are detected, controls the straightening device in such a way that the forming is ended.

19. The arrangement as claimed in claim 18, characterized in that the controller is designed in such a way that, for ending the forming, the straightening device is controlled to maintain the forming force, reduce the forming force or discontinue the forming force.

20. The arrangement as claimed in claim 18, characterized in that the arrangement is designed for the forming to be repeated after it has been ended, until the component reaches a desired final form.

21. A computer program product comprising code that can be executed on a computer, for carrying out the method as claimed in claim 11.
